(19) United States
(12) Patent Application Publication
(10) Pub. No.: US 2003/0050739 A1
(43) Pub. Date: Mar. 13, 2003

(54) Method of value resin optimization for automotive components

(76) Inventors: Bennie Clayborne Jackson, Dearborn, MI (US); Yvette Nicole Thompson, Southfield, MI (US)

Correspondence Address: DANIEL H. BLISS, 2075 WEST BIG BEAVER ROAD, SUITE 600, TROY, MI, 48084, US

(21) Appl. No.: 09/682,513

(22) Filed: Sep. 13, 2001

(51) Int. Cl. G06F 17/00

(52) U.S. Cl. 701/1

(57) ABSTRACT

A method of value resin optimization of automotive components includes the steps of evaluating value resins used for the automotive components and updating a list of the value resins. The method also includes the steps of accessing the list of value resins and selecting a resin specification from the list of value resins for the automotive component.

### BACKGROUND OF INVENTION

The present invention relates generally to methods of doing business and, more specifically, to a method of value resin optimization for automotive components.

It is known to design a component for a vehicle such as an automotive vehicle. Such component may be, for example, a cup holder that is to be installed on the automotive vehicle. Typically, the cup holder is made from a resin of a plastic material. When designing the cup holder, there may be over two thousand possible resin variations specified for the cup holder based on thirteen different vehicle platforms and one hundred fifty approved resin specifications.

As a result, the process for designing a component for a vehicle is complex and the new technology is slow to be introduced into vehicles. This process suffers from the disadvantage that the resin selected may not be compliant with vehicle content and may result in low volume levels of resin purchased. This process also suffers from the disadvantage that communications are fragmented, it is not clearly defined, new technologies are inconsistent across vehicle platforms, and resources are inefficiently used.

As a result, it is desirable to provide a method of searching value resin functionality. It is also desirable to provide a method that optimizes a number of approved resin specifications required for various automotive components. It is further desirable to provide a computerized method that can be used for value resin search functionality for part optimization and consolidation.

### SUMMARY OF INVENTION

Accordingly, the present invention is a method of value resin optimization of automotive components. The method includes the steps of evaluating value resins used for the automotive components and updating a list of the value resins. The method also includes the steps of accessing the list of value resins and selecting a resin specification from the list of value resins for the automotive component.

One advantage of the present invention is that a method is provided of value resin optimization of automotive components. Another advantage of the present invention is that the method is used to optimize the number of approved resin specifications required for various automotive components. Yet another advantage of the present invention is that the method reduces complexity and a value resins list from thousands of resins to less than one hundred resins. Still another advantage of the present invention is that the method speeds new technology introductions and makes new technologies consistent across vehicle platforms. A further advantage of the present invention is that the method improves compliance with vehicle content. Yet a further advantage of the present invention is that the method improves and streamlines communications throughout the value chain. Still a further advantage of the present invention is that the method is a clearly defined process. Another advantage of the present invention is that the method achieves economy of scale and reduces inventory costs. Yet another advantage of the present invention is that the method recommends virgin and recycled resins. Still another advantage of the present invention is that the method is web accessible.

Other features and advantages of the present invention will be readily appreciated, as the same becomes better understood, after reading the subsequent description taken in conjunction with the accompanying drawings.

### BRIEF DESCRIPTION OF DRAWINGS

FIG. 1 is a flowchart of a method, according to the present invention, of value resin optimization of automotive components.

FIG. 2 is a table of a value resins list used with the method of FIG. 1.

FIG. 3 is a screen image of a value resins search used with the method of FIG. 1.

### DETAILED DESCRIPTION

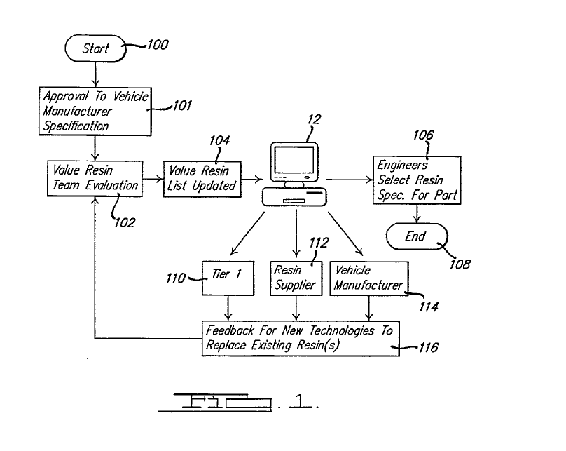

Referring to the drawings and in particular FIG. 1, one embodiment of a method, according to the present invention, of value resin optimization for automotive components is shown. The method is to be carried out on a computer system 12 that includes a computer having a memory, a processor, a display and user input mechanism, such as a mouse or keyboard (not shown).

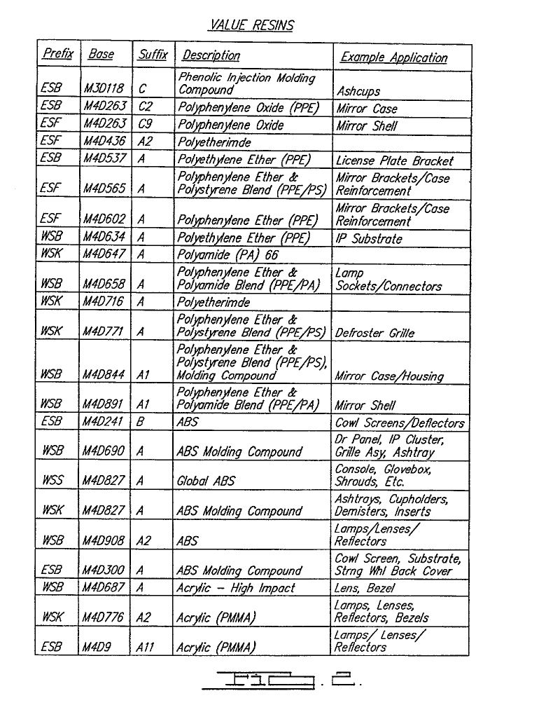

The method is used to optimize the number of approved resin specifications required for various automotive components. In the present invention, the method starts in block 100 and starts with approval of a resin of a plastic material such as polystyrene to a vehicle manufacturer specification. For example, the vehicle manufacturer has a specification of materials for a particular vehicle. Once the resin is approved to the vehicle manufacturer specification, the method advances to block 102 and is evaluated by a value resin team. In one embodiment, the value resin team is a plurality of persons from the vehicle manufacturer who have experience with resins and review new resin technologies and update a value resin list every month. For example, a vehicle manufacturer resins task force strategic commodity team comprises of research vehicle team materials engineering and purchasing reviews all submissions to the value resin list from resin suppliers and plastic molders and makes informed decisions related to which materials will be added and/or removed from the list. After block 102, the method advances to block 104 and the value resin list is updated. In one embodiment, the value resin list is a list of global resins such as polystyrene, polyethylene, etc., in both virgin and recycled states as illustrated in FIG. 2. Each value resin on the value resins list has a prefix, specification or base number, suffix, description, and example application. The value resin list may be stored on a server memory, the memory of the computer system 12, a magnetic disk storage device, or any one of numerous other electronic or magnetic storage devices. It should be appreciated that the value resin list is updated every month by the value resin team. It should also be appreciated that the value resin list is web-based.

Once the value resin list is updated in block 104 and stored on the computer system 14, the method may advance to block 106. In block 106, the method allows a designer such as an engineer to select a resin from the value resin list to be used by the designer in designing automotive components. For example, the designer may select a value resin specification such as polyethylene for a cup holder using the computer system 14. After block 106, the method advances to block 108 and ends.

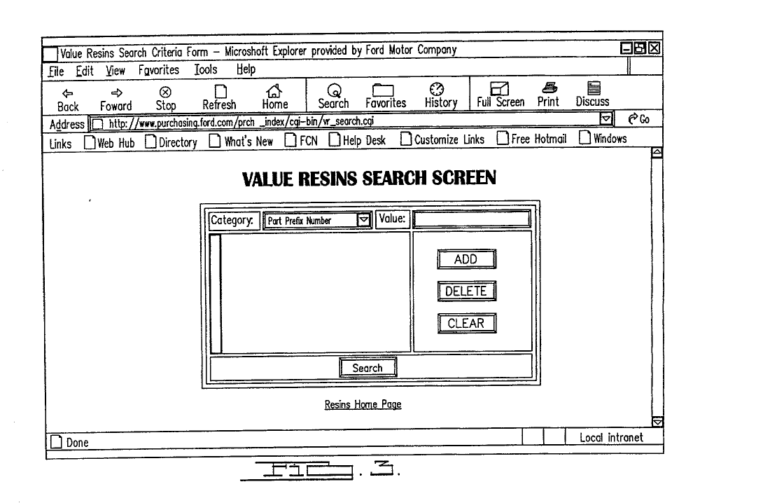

Once the value resin list is updated in block 104 and stored on the computer system 14, the method may advance to blocks 110, 112, 114. In blocks 110, 112, and 114, the method allows the value resin list to be accessed via the computer system 12 by plastic molders, resin suppliers, and vehicle manufacturer. The method advances to block 102 and divides the historical period up into time segments, for example quarters or days. The method then advances to block 104. It should be appreciated that the value resin list provides cost avoidance for vehicle manufacturer program teams, buyers, and engineers. For example, the plastic molders, resin supplier, and vehicle manufacturer accesses the computer system 14 via a resins website and allows the user to search by material description, resin family, specification number, sample application, and resin supplier via a value resins search screen as illustrated in FIG. 3. The search will provide results from the list in FIG. 2. It should be appreciated that the website offers a comprehensive list of recycled and biodegradable plastics for interior and exterior applications. It should also be appreciated that the website may provide feedstock information (Stochiometry) and current and future market prices for a particular resin such as polyethylene. It should further be appreciated that the method allows access to value resins by both internal and external users of the vehicle manufacturer.

After either block 110, 112, 114, the method advances to block 116 and supplies feedback for new technologies to replace existing resin(s). For example, the tier buyer, resin supplier, and vehicle manufacturer may submit a new resin to replace an existing resin via the computer system 14. If so, the method advances to block 102, previously described, and the vehicle manufacturer resins task force strategic commodity team reviews all new submissions to the value resin list and makes informed decisions related to which materials will be added and/or removed from the list. For example:

| Current Process | Method of Present Invention |
|---|---|
| Component: Cup Holder | Component: Cup Holder |
| 13 Vehicle Platforms | 13 Vehicle Platforms |
| 160 Approved Resins | 3 Approved Resins |
| 2,080 Possible Var. | 39 Possible Variations (Var.) |

It should be appreciated that the method optimizes the number of approved resin specifications required for various automotive components.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A method of value resin optimization of automotive components, said method comprising the steps of:
evaluating value resins used for the automotive components;
updating a list of the value resins;
accessing the list of value resins; and
selecting a resin specification from the list of value resins for the automotive component.

2. A method as set forth in claim 1 including the step of approving a value resin to a vehicle manufacturer specification prior to said step of evaluating.

3. A method as set forth in claim 1 wherein said step of accessing the list of value resins includes accessing the list by one of a tier buyer, resin supplier, and vehicle manufacturer.

4. A method as set forth in claim 3 including the step of submitting a new value resin to replace at least one value resin on the list of value resins by either one of the tier buyer, resin supplier, and vehicle manufacturer.

5. A method as set forth in claim 1 wherein said step of accessing includes searching the list of value resins by at least one predetermined criteria.

6. A method as set forth in claim 5 wherein said predetermined criteria comprises a specification number, material description, resin supplier, and sample application.

7. A method as set forth in claim 1 wherein said step of evaluating comprises reviewing all submissions to the list of value resins and making informed decisions related to which materials will be added and/or removed from the list of value resins.

8. A method as set forth in claim 1 wherein said step of updating comprises updating the list of value resins every predetermined time period.

9. A method as set forth in claim 8 wherein said predetermined time period is one month.

10. A method as set forth in claim 1 including the step of storing the list of value resins on a computer system.

11. A computerized method of value resin optimization of automotive components, said method comprising the steps of:
evaluating value resins used for the automotive components;
updating a list of the value resins;
storing the list of the value resins on a computer system;
accessing the list of value resins; and
selecting a resin specification from the list of value resins for the automotive component.

12. A computerized method as set forth in claim 11 including the step of approving a value resin to a vehicle manufacturer specification prior to said step of evaluating.

13. A computerized method as set forth in claim 11 wherein said step of accessing the list of value resins includes accessing the list by one of a tier buyer, resin supplier, and vehicle manufacturer.

14. A computerized method as set forth in claim 13 including the step of submitting a new value resin to replace at least one value resin on the list of value resins by either one of the tier buyer, resin supplier, and vehicle manufacturer.

15. A computerized method as set forth in claim 11 wherein said step of accessing includes searching the list of value resins by at least one predetermined criteria.

16. A computerized method as set forth in claim 15 wherein said predetermined criteria comprises a specification number, material description, resin supplier, and sample application.

17. A computerized method as set forth in claim 11 wherein said step of evaluating comprises reviewing all submissions to the list of value resins and making informed decisions related to which materials will be added and/or removed from the list of value resins.

18. A computerized method as set forth in claim 11 wherein said step of updating comprises updating the list of value resins every predetermined time period.

19. A computerized method as set forth in claim 18 wherein said predetermined time period is one month.

20. A method of value resin optimization of automotive components, said method comprising the steps of:
evaluating value resins used for the automotive components;
updating a list of the value resins;
storing the list of the value resins on a computer system;
accessing the list of value resins by one of a tier buyer, resin supplier, and vehicle manufacturer; and
submitting a new value resin to replace at least one value resin on the list of value resins by either one of the tier buyer, resin supplier, and vehicle manufacturer.
